(19) United States
(12) Patent Application Publication
(10) Pub. No.: US 2015/0110007 A1
(43) Pub. Date: Apr. 23, 2015

(54) REMOTELY CONFIGURABLE MOBILE APPLICATION HAVING BEARER SELECTION

(71) Applicant: Mistral Mobile, Oulu (FI)

(72) Inventor: TIMO P. TERVO, Oulu (FI)

(73) Assignee: Mistral Mobile, Oulu (FI)

(21) Appl. No.: 14/059,350

(22) Filed: Oct. 21, 2013

(51) Int. Cl. H04W 4/00; H04W 28/02

(52) U.S. Cl. CPC H04W 4/001; H04W 28/0263
USPC 370/329

(57) ABSTRACT

Methods and apparatus, including computer program products, are provided for automatic bearer selection. In one aspect there is provided a method. The method may include receiving, at a mobile application, bearer configuration information representative of one or more features of the mobile application mapped to at least one of a low capacity bearer or a high capacity bearer; determining, at the mobile application, a context of the mobile application, the context determined by at least determining a feature selected via the mobile application and determining an identity of a bearer mapped to the feature in the received bearer configuration information; selecting, based on the determining, the at least one of the low capacity bearer or the high capacity bearer; and allowing the feature to access the selected at least one of the low capacity bearer or the high capacity bearer. Related apparatus, systems, methods, and articles are also described.

### TECHNICAL FIELD

The subject matter disclosed herein relates a remotely configurable mobile application.

### BACKGROUND

In the mobile payment ecosystem, and particularly in so-called emerging or high-growth markets, there is a need to update and modify consumers′, agents' or merchant's set of features frequently. Similar needs are met in other areas of business, such as insurance or rental related services. The need arises from the fact that in growth market services, such as financial or insurance services, are nascent and feature proliferation and corresponding updates occur with high frequency. In some growth markets, end-users may also upgrade from one consumer category to another to gain access to new or improved services. For example, end-users may initially use a mobile payment service without providing any legal documents (if permitted by applicable regulations) to initially use closed-loop products before executing proper know-your-customer processes and thereby gaining access to semi-closed or open-loop services, in which a broader set of features may be available. As a consequence, companies providing services, such as financial, insurance, or rental services, through mobile applications in some high-growth markets (in which there is limited connectivity context) typically face the challenge of updating and modifying features sets available on mobile service applications.

In developed markets, frequent feature updates or modifications are typically addressed by re-downloading and re-installing a complete mobile application over the air via an Internet Protocol (IP) channel. But in the high-growth markets, some users may not have a data channel, for example a data subscription in addition to a voice subscription, available to execute the re-download and re-installation of the mobile application. As a consequence, these emerging, high-growth region users typically rely on visiting an agent (for example, a correspondent or other entity) who can perform an update via for example a manual installation from a memory card or a side-load with personal computer (PC) or the like.

Several different solutions for configuring mobile devices automatically have been proposed. However, these solutions are typically based on creating matching definition files both on the server side and application/device side, providing specific configuration and identification modules that are integrated into a larger network management system or allowing users to download programs or applications that partially reconstitute the existing programs or applications. All of these solutions typically also require well-established network conditions and data subscriptions with high data transfer capability.

### SUMMARY

Methods and apparatus, including computer program products, are provided for automatic bearer selection.

In one aspect there is provided a method. The method may include receiving, at a mobile application, bearer configuration information representative of one or more features of the mobile application mapped to at least one of a low capacity bearer or a high capacity bearer; determining, at the mobile application, a context of the mobile application, the context determined by at least determining a feature selected via the mobile application and determining an identity of a bearer mapped to the feature in the received bearer configuration information; selecting, based on the determining, the at least one of the low capacity bearer or the high capacity bearer; and allowing the feature to access the selected at least one of the low capacity bearer or the high capacity bearer.

In some implementations, the above-noted aspects may further include additional features described herein including one or more of the following. The bearer configuration information previously configured for the mobile application may be modified. The bearer configuration information may be representative of a priority order giving a preference to at least one bearer over another bearer, and the at least one bearer or the other bearer in the priority order may be selected based on context. A performance of a device hosting the mobile application may be determined. A determination may be made regarding whether to allow the feature based on the determined performance. The low capacity bearer may include at least one of a short message service bearer, a secure short message service bearer, and an unstructured supplementary service data bearer. The high capacity bearer may include an internet protocol bearer. The context further may include at least one of the following: a bandwidth requirement of the feature; a user preference for the low capacity bearer or the high capacity bearer; an availability of the low capacity bearer or the high capacity bearer; a network service provider preference for the low capacity bearer or the high capacity bearer; costs associated with the low capacity bearer or the high capacity bearer; a location of the mobile application; reliability of for the low capacity bearer or the high capacity bearer; and quality of service of the low capacity bearer or the high capacity bearer unreliability of user bearer.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1A shows an example of a system including a mobile application configured to select between a low capacity bearer and a higher capacity bearer, in accordance with some example embodiments;

FIG. 1B shows a flow chart describing an example of a process for selecting between a low capacity bearer and a higher capacity bearer, in accordance with some example embodiments;

FIG. 1C depicts an example of an apparatus including a mobile application and a bearer selector, in accordance with some example embodiments;

FIG. 1D shows a schematic representation of a system for a remotely configurable mobile application, in accordance with some example embodiments;

FIG. 2 shows a flow chart describing an example of a high-level scenario for initializing a remotely configurable mobile application and changing the menu and functionality of the initial remotely configurable mobile application in a mobile device, in accordance with some example embodiments;

FIG. 3 shows a flow chart describing an example of a high-level scenario for disabling and enabling a remotely configurable mobile application in a mobile client device, in accordance with some example embodiments;

FIG. 4 shows a flow chart describing an example of a high-level scenario for blocking and unblocking a remotely configurable mobile application in a mobile client device, in accordance with some example embodiments;

FIG. 5 shows a flow chart describing an example of a high-level scenario for a complete service transaction, in accordance with some example embodiments;

FIG. 6 shows an signaling diagram for a certain type of service transaction, in accordance with some example embodiments; and

FIG. 7 shows an example of initializing and modifying the menu and functionality of a remotely configurable mobile application in a configuration server by utilizing tools with a graphical user interface for the configuration, in accordance with some example embodiments.

Like labels are used to refer to same or similar items in the drawings.

### DETAILED DESCRIPTION

When features are defined for a mobile application, such as a mobile payment application, a banking application, an e-commerce application and any other type of application, some of the features may be executed using limited bandwidth connectivity as found in for example, short message service (SMS), secure SMS, unstructured supplementary service data (USSD), and the like. However, the mobile application may have some features (for example, functionality, use cases, and the like) requiring more bandwidth than is available via these limited SMS, secure SMS, or USSD bearers. This additional bandwidth requirement may be due to for example the requirements of the data exchange between the mobile application and a server.

To illustrate further, a mobile application related to a movie, an airline reservation, a bus ticket reservation, a stock application for obtaining quotes or making trades, an on-line shopping application, and the like may all require a substantial amount of information to be exchanged bilaterally between the mobile application and the server to complete the exchange and thus provide the information related to the movie, reservation, and the like. In these high-bandwidth use cases, information transfer via SMS can require multiple message roundtrips. As such, the use of SMS may not be very cost efficient and suffer from a usability perspective (for example, due to the delay, the cost, and/or the like associated with the multiple SMS roundtrips to provide the data exchange), when compared to for example a more robust data connection, such as an internet protocol (IP) connection. Moreover, the mobile application may be configured to have certain features that should be available even when there is no IP data connection, or a certain feature may be configured to have a preference or requirement to not be carried over the IP connection. For example, a mobile application may have a feature for money transfer, balance requests, mini-statements, and the like, and these types of features may be of the type which are configured to be available even when there is no IP data connectivity.

The subject matter disclosed herein may provide, in some example embodiments, a mobile application including a bearer selector. The bear selector may be configured to determine, for one or more features being used by the mobile application, a type of bearer to be used by the mobile application. For example, the bearer selector may be configured to select a low capacity bearer, such as an SMS bearer, secure SMS bearer, or USSD bearer, for certain features, but select a higher capacity bearer, such as an IP bearer, for certain other features. To illustrate further, the bearer selector may select a low capacity bearer, such as an SMS bearer, when a money transfer feature is being used at the mobile application, and select a higher bandwidth bearer, such as an IP bearer, when a delay intolerant or higher-bandwidth features is being used. As such, the bearer selector may be able to select the type of bearer based on the context of the mobile application.

In some example embodiments, the mobile application having the bearer selector may select a low capacity bearer, such as an SMS bearer, a secure SMS bearer, or a USSD bearer, when the low capacity bearer is sufficient to support a given feature at the mobile application, but select a second, higher capacity bearer in situations requiring higher bandwidth, lower delay, and for any other configured reason.

In some example embodiments, the mobile application may have one or more different features having different types of connection requirements and different behaviors depending on for example available connection speed, context of the mobile application, and the like. When this is the case, the mobile application including the bearer selector may be configured (by, for example, a configuration server or other entity) to allow selection, based on the configuration, between the first, low capacity bearer and the higher capacity bearer.

In some example embodiments, the bearer selector may select among bearers, such as between low capacity bearer (for example, an SMS bearer, USSD bearer, and the like) and a higher capacity data bearer (for example, IP bearer), and this selection may be based on a given context. For example, the context may represent one or more of the following: what feature is being used at the mobile application (for example, a data intensive feature of the mobile application versus a less data demanding feature which is amenable to SMS); bandwidth requirements of the feature; a user preference (for example, a preference to use SMS over a data connection); an availability of an SMS bearer or an IP bearer; a service provider and/or network service provider preference (for example, a preference to avoid more than a predetermined amount of SMS message exchanges between the mobile application and a server); costs associated with an SMS bearer or an IP bearer; location of the mobile application/device (for example, in certain locations or networks, there may be a preference for an SMS bearer or a data bearer, or in certain locations there might be data network roaming which is not available or at a cost that is prohibitive or expensive); unreliability of user bearer (for example, an SMS bearer might be unreliable at certain context and a user may thus prefer to use data), and/or the like.

The connection requirement for the feature may be defined when the feature is implemented or defined in a configuration server (described further below). For example, an administration tool at the configuration server may be used to define (for example, configure) the feature and the associated connectivity requirement, such as whether a low capacity bearer or a higher capacity bearer is preferred or required.

To illustrate with an example, a user may be visiting a rural area of a region, such as India. In this region, there is little or no data connectivity available but the user still needs to execute a money transfer. Due to automatic bearer selection disclosed herein, the application may thus be able to switch automatically from data to SMS, so the bearer configuration instructions enable use of SMS for this type of transaction. In another example, a user is about to make a travel reservation for a trip. In this use case of a flight booking, it normally requires a large data exchange with the reservation/booking service. Therefore, a requirement may be placed that an IP bearer be used for this use case. And, if the IP bearer is available, then the user is able to execute the flight booking application. However, if an IP bearer is not available, then the flight booking application may throw an exception, such as feature not available please switch on mobile data or connect yourself to WLAN if available.

In some example embodiments, when the configuration for a feature of the mobile application is associated with a certain communication bearer and that bearer is not available, the mobile application may notify the user with an appropriate message, such as for example “feature is not available due to lack of data connectivity.” To illustrate further, if the mobile application has a feature requiring an SMS connection (for example, due to the security or encryption provided by the SMS connectivity) and SMS connectivity is not currently available, then the mobile application may present a message at a user interface stating “feature is not available due to lack of SMS connectivity.” Similarly, if the mobile application has a feature requiring a data connection, such as IP connectivity (for example, due to the greater bandwidth and capacity provided by the data connection) and data connectivity is not currently available, then the mobile application may present a message at a user interface stating “feature is not available due to lack of data connectivity” or “insufficient data speed.”

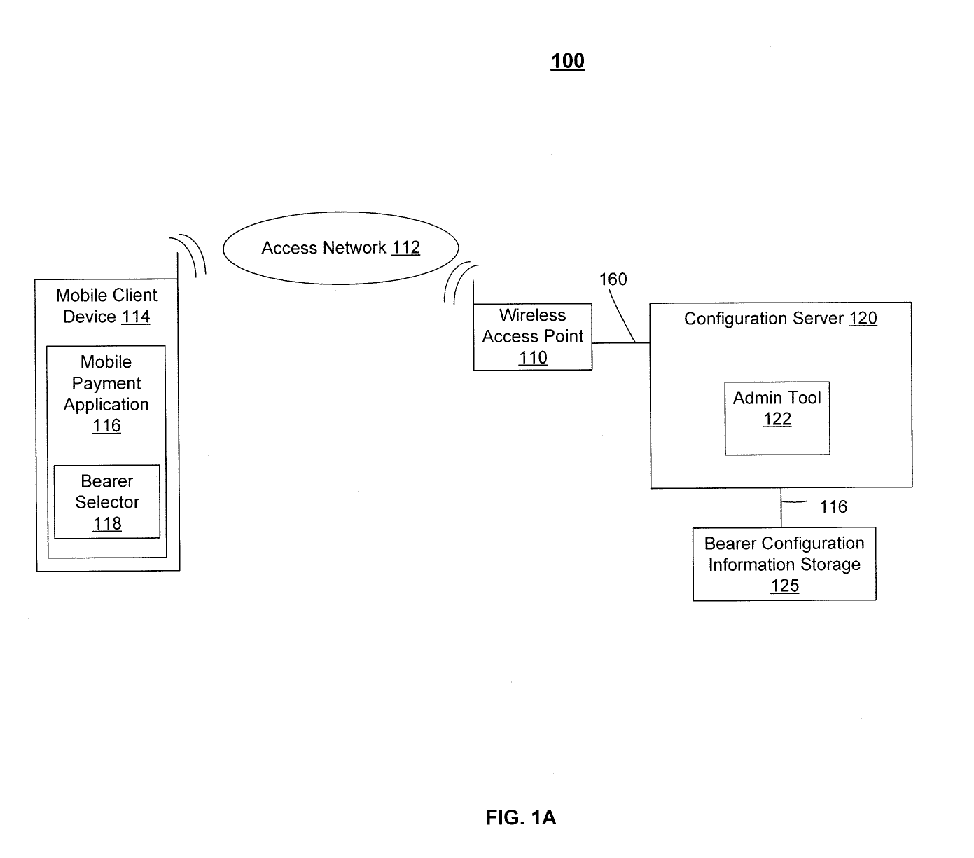

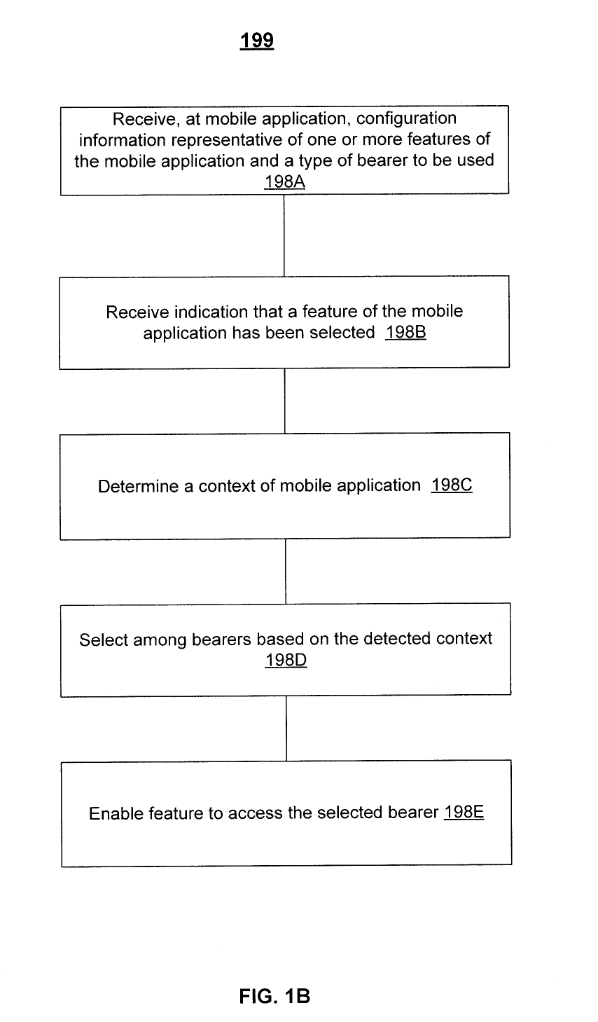

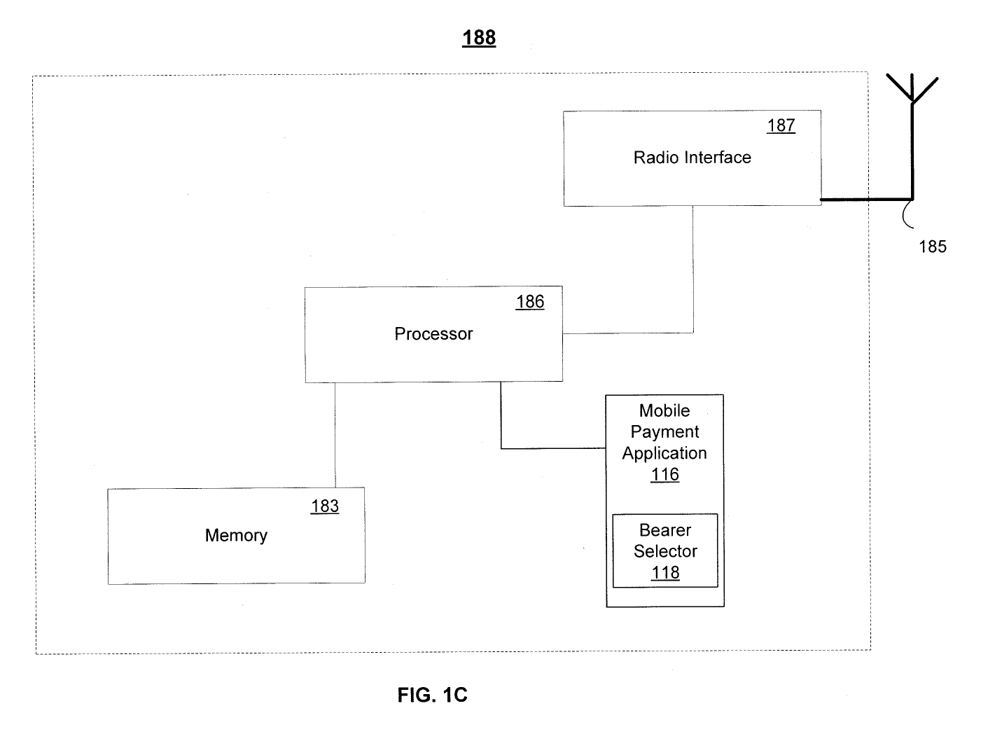

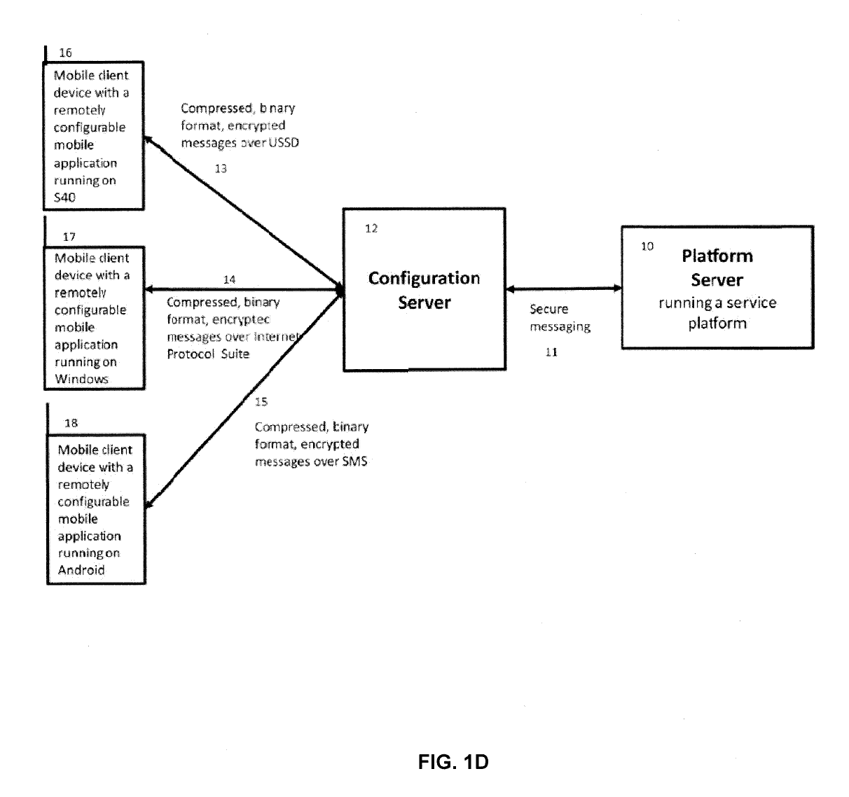

FIG. 1A depicts an example system 100, in accordance with some example embodiments.

The system 100 may include one or more devices, such as mobile client device 114. The mobile client device 114 may be implemented as a mobile device and/or a stationary device. The mobile client device 114 may be referred to as, for example, a mobile station, a mobile unit, a subscriber station, a wireless terminal, a tablet, a smart phone, user equipment, a wireless device, or the like. The mobile client device 114 may include processor circuitry, memory (which may include computer program code executable by the processor circuitry), a user interface, and a radio interface (for example, a radio modem). The radio interface of the mobile client device 114 may be capable of operating with one or more types of wireless air interface standards, communication protocols, modulation types, access types, and the like. For example, the mobile client device 114 and/or a radio interface therein may be capable of operating in accordance with one or more of the following: various first generation (1G) communication protocols, second generation (2G or 2.5G) communication protocols, third-generation (3G) communication protocols, fourth-generation (4G) communication protocols, wireless local area network (WLAN) protocols, and any other type of air interface.

The mobile client device 114 may further include a mobile application, such as mobile payment application 116. The mobile application is mobile in the sense that it is executed in a mobile device. The mobile client device 114 may be configured by a configuration server 120 as described further below.

Although FIG. 1A depicts a mobile payment application, other types of applications may be implemented as well.

The mobile payment application 116 may include a bearer selector 118. The bearer selector 118 may be configured to select among bearers, such as between a low capacity bearer and a higher capacity bearer. The selection between the bearers may be defined by the configuration server 120. Specifically, the configuration server 120 may provide to the mobile payment application 116 bearer configuration information defining one or more features available via the mobile application and the required or preferred type of bearer to be used by the mobile application 116. For example, the bearer configuration information may define that the mobile application 116 should use an IP data bearer for a first feature and use an SMS bearer for a second feature. Moreover, the bearer configuration information provided by the configuration server may also take into account other conditions associated with the context of the mobile application. Those other conditions may include network service provider preferences (for example, a preference to use one bearer over another if available); a user preference to use one bearer over another; a service provider preference for a given bearer; costs associated with an SMS bearer versus an IP/data bearer; a location of the mobile application; bandwidth requirements; delay requirements; availability requirements (for example, always on or critical features may require an SMS connection); security requirements (for example, always on or critical features may require an SMS connection or secure SMS connection); quality of service requirements; data rate requirements; and/or any other conditions. Moreover, the selection of a low capacity bearer or a higher capacity bearer may take into account one or more of these and other conditions.

The mobile payment application 116 having the bearer selector 118 may select from among one or more bearers available given the radio access technology (RAT) being used, such as for example GPRS, 3G, 4G, WCMDA, WLAN, LAN, SMS, and any other RAT. Moreover, the bearer selector 118 may be configured to select a given bearer given the available bearers for a given air interface.

The mobile client device 114 may access a wireless access point 110 via access network 112, such as a radio access network. For example, wireless access point 110 may be implemented as a base station, WiFi access point, and/or any other type of wireless access point capable of serving access network 112 (including for example another mobile client device). The wireless access point 110 may be configured to operate with one or more types of wireless air interface standards, communication protocols, modulation types, access types, and the like. For example, the mobile client device 114 and/or a cellular modem therein may be capable of operating in accordance with various 1G communication protocols, 2G or 2.5G communication protocols, 3G communication protocols, 4G communication protocols, wireless local area network communication protocols, SMS, USSD, and any other types of air interfaces, protocols, modulation types, and the like.

Moreover, the access point 110 may include one or more links, such as backhaul link 160, to other networks (for example, other mobile networks, the Internet, and the like), network nodes (for example, configuration server 120), and the like.

In some example embodiments, configuration server 120 may provide to mobile payment application 116 the bearer configuration information including the types of bearers to use for one or more features available via the mobile payment application. For example, the bearer configuration information may define using a low capacity bearer, such as SMS, secure SMS, USSD, and the like, for certain features at the mobile payment application, and define using a higher capacity bearer, such as SMS, secure SMS, USSD, and the like, for certain features at the mobile payment application.

The configuration server 120 may further include an administration tool 122 (labeled admin tool). The administration tool 122 may provide tools to allow defining the bearer configuration information for a mobile application. For example, administration tool 122 may include a user interface to allow features of the mobile application to be mapped to a bearer types, such as the low capacity bearer or the higher capacity bearer. The administration tool 122 may allow the generation of rules representative of the bearer configuration information for the mobile application. To illustrate, a rule may define that a certain feature of the mobile application should use an SMS connection, but if the SMS connection is not available, a message should be presented at the user interface of the mobile client device to indicate that the SMS bearer is not available. The bearer configuration information may be stored at 125 and provided to mobile payment application 116 via link 160, wireless access point 110, and access network 112.

Although FIG. 1A depicts a certain quantity and configuration of certain devices, other quantities, configurations, and types of devices may be used as well.

FIG. 1B depicts a process 199 for bearer selection, in accordance with some example embodiments. The description of process 199 also refers to FIG. 1A.

At 198A, the mobile client device 114 including the mobile payment application 114 and bearer selector 118 may receive at least bearer configuration information from configuration server 120. The bearer configuration information may represent one or more features of a mobile application, such as mobile payment application 116, and associated types of bearers to be used. For example, the bearer configuration information may define that if a money transfer, balance request, and/or other certain type of feature is being invoked at mobile payment application 116, SMS connectivity is preferred or required. Table 1 below depicts an example of bearer configuration information, although other formats may be used as well.

TABLE 1

| Feature | Rule |
|---|---|
| money transfer | SMS bearer |
| balance request | SMS bearer |
| High bandwidth feature | IP bearer |
| Mini-statement 5 items | SMS bearer |
| Account monthly statement | IP bearer |
| Travel reservation payments with booking | IP bearer |
| Stock exchange reports | IP bearer |
| Movie ticket payments and seat reservation | IP bearer |
| Recharge mobile SIM | SMS bearer |
| Pay Bill | SMS bearer |

At 198B mobile payment application 114 and/or bearer selector 118 may receive an indication that a feature has been invoked. For example, when a money transfer is selected, this may trigger an indication to be sent to by the mobile client device 114 to the mobile payment application 114 and/or bearer selector 118.

The received indication at 198B may prompt the mobile payment application 114 and/or bearer selector 118 to determine the context, at 198C, of the mobile application. For example, the mobile payment application 114 and/or bearer selector 118 may assess the bearer configuration information and the received indication. Returning to the money transfer example, the context may represent “money transfer” and “SMS bearer.”

At 198C, the bearer selector 118 may select among bearers based on the determined context. For example, the bearer selector 118 may select among bearers, such as an IP bearer and an SMS bearer, based on the context. Returning to the money transfer example, the context represents “money transfer” (which is the feature being invoked) and “SMS bearer” (which is the mapped bearer determined from the bearer configuration information). In this example, the bearer selector 118 selects the SMS bearer for the money transfer.

At 198C, the mobile payment application 114 and/or bearer selector 118 may enable the feature to use the bearer selected at 198C. Returning to previous example, the money transfer feature is allowed (or configured to use) the SMS bearer selected by the bearer selector 118 at 198C. As such, the money transfer feature can exchange messages with a server via SMS connectivity.

FIG. 1C depicts an example implementation of an apparatus 188, such as mobile client device 114. The apparatus 188 may include one or more antennas 185 configured to transmit and/or receive via links to wireless access point 110. The apparatus 188 may include or be coupled to other servers, such as configuration server 120, platform server 10 (described further below), and/or other networks, nodes, and the like. The apparatus 188 may further include a plurality of radio interfaces 187 coupled to the antenna 185. The radio interfaces may correspond to one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as 802.11 WiFi and the like, 1G, 2G, 3G, 4G, WiBro, Bluetooth, Bluetooth low energy (BT-LE), near field communications (NFC), and any other radio access technologies. The radio interface 187 may further include other components, such as filters, converters (for example, digital-to-analog converters and the like), mappers, a Fast Fourier Transform (FFT) module, and the like, to generate symbols for a transmission via one or more downlinks and to receive. The apparatus 188 may further include one or more processors, such as processor 186 for controlling the apparatus 188 and for accessing and executing program code stored in memory 183. The code for the mobile application 116 and bearer selector 118 may, in some example embodiments, also be stored at memory 183 and executed by processor 186. In some example embodiments, memory 183 includes code, which when executed by at least one processor causes one or more of the operations described herein with respect to mobile client device 114, such as process 199 and the like.

The configuration server 120 may further include one or more processors (for example, processor circuitry) for accessing and executing program code stored in memory, and the memory may include code, which when executed by at least one processor causes one or more of the operations described herein with respect to configuration server 120, such as provide the bearer configuration information and other aspects as disclosed herein.

FIG. 1D depicts an example embodiment of a system for a remotely configurable mobile application. The system may include at least one configuration server 12, at least one platform server 10 running the actual service platform and one or more mobile client devices 16-18.

The mobile client devices may each include a mobile application, such as a mobile payment application 116, although any other type of application may be used as well. Moreover, the mobile application may include a bearer selector 118 as disclosed herein.

The mobile application may be implemented, in some example embodiments, as a remotely configurable mobile application running on any mobile operating system (OS) such as Android, Windows Mobile, Series40 (S40), SailFish, or iPhone OS, for example, but not limited to these.

In some example embodiments, the configuration of the mobile application is created and the mobile application is managed in the configuration server 12. In some example embodiments, the configuration server 12 may be implemented as disclosed above with respect to configuration server 120. When that is the case, the configuration server may include an administrative tool 122 and may access configurations 125.

The configuration server 12 and one or more mobile client devices 16-18 may communicate by utilizing compressed, binary format, encrypted communication and management messages 13-15 that are sent over, for example but not limited to, a limited, narrow communication channel such as Short Message Service (SMS), Unstructured Supplementary Service Data (USSD) or Internet Protocol Suite (IP Suite).

The configuration server 12 may couple to a platform server 10, which runs the actual service platform and is independent of the configuration server 12. The configuration server may communicate with the platform server through a secure connection and communication channel 11. The secure connection may comprise one or more SMS connections and/or one or more data connection, and these connections may be encrypted as well.

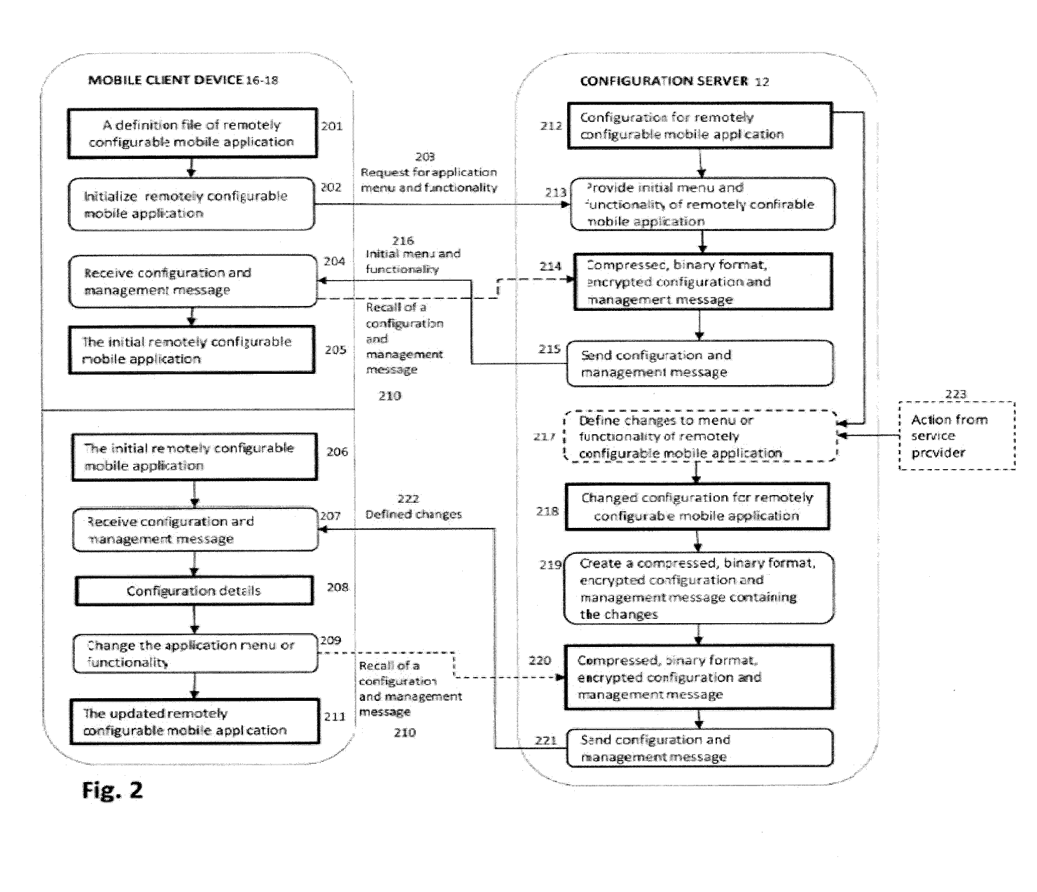

FIGS. 2-4 depict example processes according to some example embodiments.

FIG. 2 depicts an example of a process for initialization of a remotely configurable mobile application and for changing the menu and functionality of the remotely configurable mobile application through configuration server, in accordance with some example embodiments.

In the example of FIG. 2, the connectivity between the mobile client device and the configuration server may be in accordance with process 199 noted above. When this is the case, the bearer selector selects the type of connectivity based on features and the like being used by the mobile client application at the mobile client device. For example, at 203, 210, 216, and 222 described below, the bearer selector may select a type of bearer based on process 199. If the configuration update corresponds to a large list, such as a large list of automated teller machines (ATM) locations in India, the application may not update the list unless data bearer is available.

The remotely configurable mobile application at the mobile client device 16, 17, or 18 is initialized 202 in the mobile client device by installing a definition file 201 for the mobile application, which then after installation enables requesting the menu and functionality for the application 203 from the configuration server holding the configuration of the application 212 according to a service that the application is matched with and provides the initial menu, related data types and functionality 213 in one or more compressed, binary format configuration and management messages 214. The configuration and management message 214 is sent to the remotely configurable mobile application in the mobile client device 215-216 and once the message containing the configuration data is received 204, the initial version of the application is ready to use 205. In some example embodiments, changes to the running initial version of the application 206 can be defined and implemented on a configuration server 217-218 while the mobile application is running the user's mobile client device based on the current configuration of the application 212 (which is stored in the server). And, the use of the remotely configurable mobile application may not be disturbed while the changes are defined at the configuration server 217. The configuration changes may be triggered by a service provider 223. The configuration changes 218 are passed to the mobile client device with the remotely configurable mobile application in a compressed, binary format configuration and management message 219-222. After the message is received 207 the menu and functionality of the mobile application are ready to be changed 209 immediately according to the received configuration details 208 and the application stays ready for use with the updated menu and functionality 211.

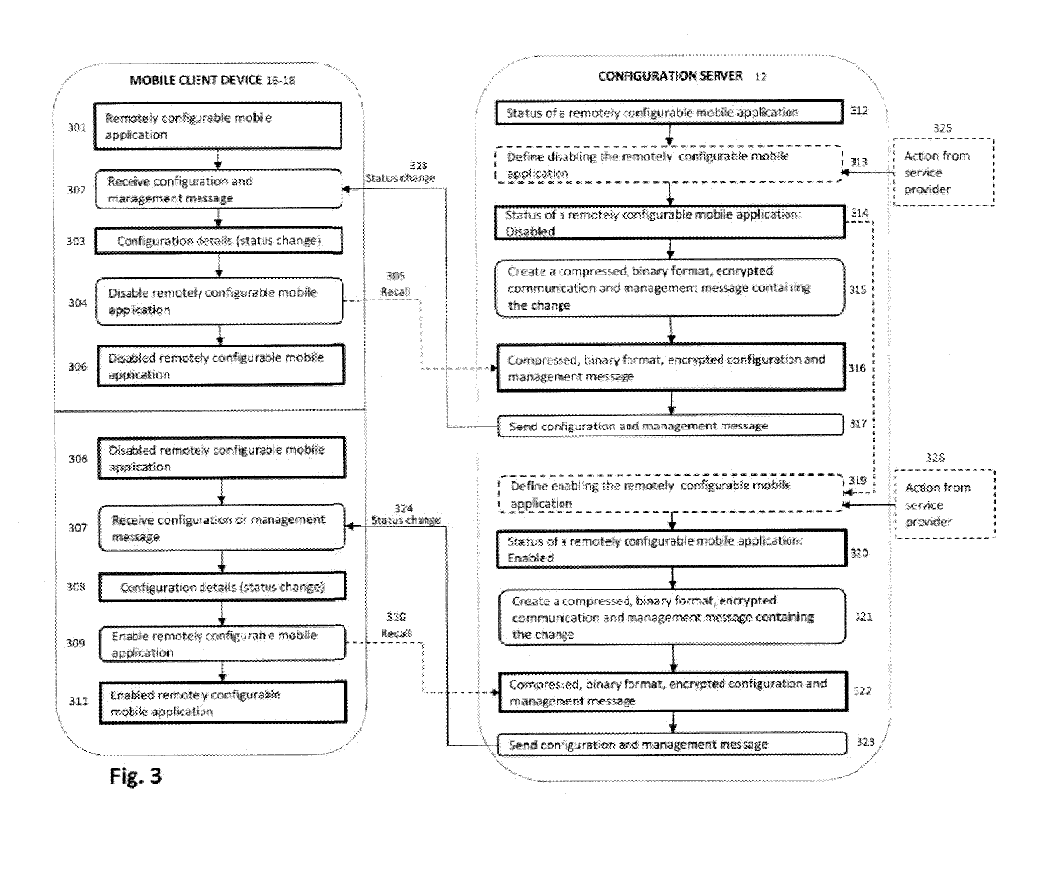

FIG. 3 illustrates an example of a process for managing a remotely configurable mobile application, in accordance with some example embodiments. For example, the managing of the remotely configurable mobile application, such as mobile payment application 116 and/or any other application, may include disabling and enabling, from a configuration server, the remotely configurable mobile application (which is being executed in a mobile client device).

In the example of FIG. 3, the connectivity between the mobile client device and the configuration server may be in accordance with process 199 noted above. When this is the case, the bearer selector selects the type of connectivity based on features and the like being used by the mobile client application at the mobile client device. For example, at 318, 305, 324, and 310 described below, the bearer selector may select a type of bearer based on process 199.

In some example embodiments, to disable the remotely configurable mobile application in the mobile client device, the configuration server 12 may be aware of the status of the remotely configurable mobile application in the mobile client device 312. And, the disabling of this mobile application may be defined, in some example embodiments, in the configuration server 313, which then tracks the status change 314. The configuration server may, in some example embodiments, create a compressed and encrypted binary format configuration and management message containing the status change information 315 for disabling the mobile application 316. The configuration server may then send 317 the message over a communication channel 318 such as SMS or USSD, for example, but not limited to these, to the the mobile application in the mobile client device. Once the message for disabling 302 the mobile application is received, the mobile application may be disabled 304 according to the received configuration details 303 and can operate accordingly 306. Defining the disabling of the application 313 is an application management action that may require interaction from a service provider controlling the use of the applications, and therefore the disabling may be triggered based on an action taken by the service provider 325.

According to the example method for enabling the previously disabled remotely configurable mobile application in the mobile client device in FIG. 3, the configuration server 12 is aware of the status of the mobile application in the mobile client device 314, and enabling the mobile application may, in some example embodiments, be defined in the configuration server 319, which then tracks the status change 320. The configuration server may, in some example embodiments, also create a compressed and encrypted binary format configuration and management message containing the status change information 321 for enabling the application 322. In addition, the configuration server may, in some example embodiments, send 323 the message over a communication channel 324, such as SMS or USSD, for example, but not limited to these, to the mobile application in the mobile client device. Once the message for enabling the application 307 is received, the mobile application may be enabled 309 according to the received configuration details 308 and can operate accordingly 311. Defining enabling the application 319 is an application management action that may require interaction from a service provider controlling the use of the applications, and therefore the enabling may be triggered based on an action taken by the service provider 326.

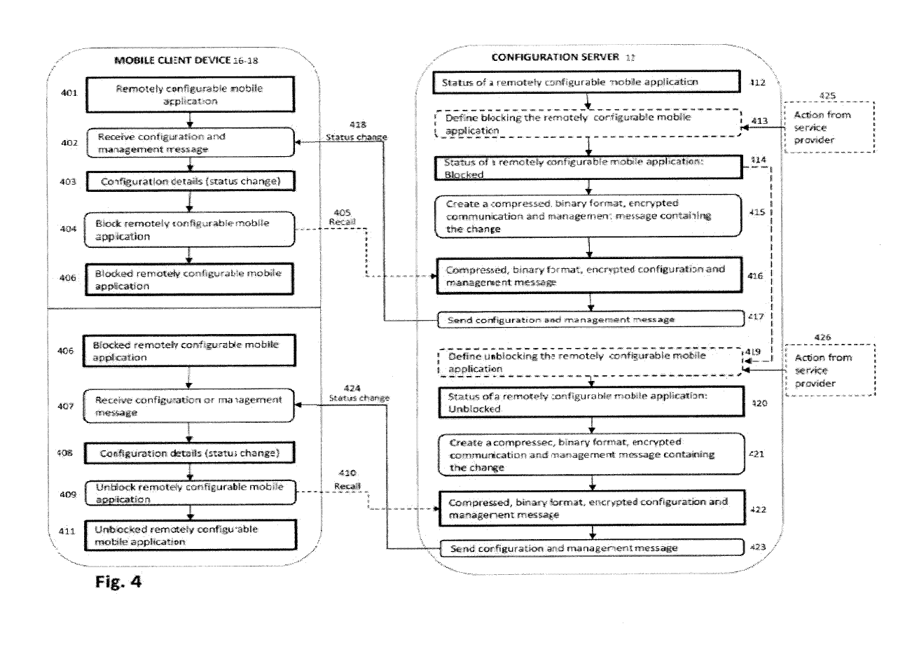

FIG. 4 illustrates an example of a process for managing a remotely configurable mobile application, in accordance with some example embodiments. For example, the managing may include blocking and unblocking the mobile application in a mobile client device from a configuration server.

In the example of FIG. 4, the connectivity between the mobile client device and the configuration server may be in accordance with process 199 noted above. When this is the case, the bearer selector selects the type of connectivity based on features and the like being used by the mobile client application at the mobile client device. For example, at 418, 405, 424, and 410 described below, the bearer selector may select a type of bearer based on process 199.

To block the remotely configurable mobile application in the mobile client device, the configuration server 12 may be aware of the status of the mobile application in the mobile client device 412. In some example embodiments, blocking the application is defined in the configuration server 413, which then tracks the status change 414. The configuration server may, in some example embodiments, create a compressed and encrypted binary format configuration and management message containing the status change information 415 for blocking 416 the mobile application. The configuration server may then send 417 the message over a communication channel 418 such as SMS or USSD, for example, but limited to these, to the mobile application in the mobile client device. Once the message for blocking the application is received 402, the mobile application may be blocked 404 according to the received configuration details 403 and can operate accordingly 406. Defining blocking the application 413 is an application management action that requires interaction from a service provider controlling the use of the applications, and therefore the blocking may be triggered based on an action taken by the service provider 425.

To unblock the previously blocked remotely configurable mobile application in the mobile client device, the configuration server 12 is aware of the status of the mobile application in the mobile client device 414, and the unblocking of the application may, in some example embodiments, be defined in the configuration server 419, which then tracks the status change 420. The configuration server 12 may, in some example embodiments, create a compressed and encrypted binary format configuration and management message containing the status change information 421 for unblocking the application 422, and the configuration server may send 423 the message over a communication channel 424, such as SMS or USSD, for example, but limited to these, to the mobile application in the mobile client device. Once the message for unblocking the application 407 is received, the mobile application may be unblocked 409 according to the received configuration details 408 and can operate accordingly 411. Defining unblocking the application 419 is an application management action that may require interaction from a service provider controlling the use of the applications, and therefore the unblocking may be triggered based on an action taken by the service provider 426.

In the example embodiments of FIGS. 2, 3, and 4, a roll-back and recall may be performed. For example, during phases 210, 305, 310, 405, and 410, the configuration and management messages passed between a mobile client device (which includes a remotely configurable mobile application) and a configuration server may be rolled back and recalled. The roll back and recall may be triggered by the mobile application in a situation where consistency between received configuration and management message and the current status or configuration of the application is not clear or complete.

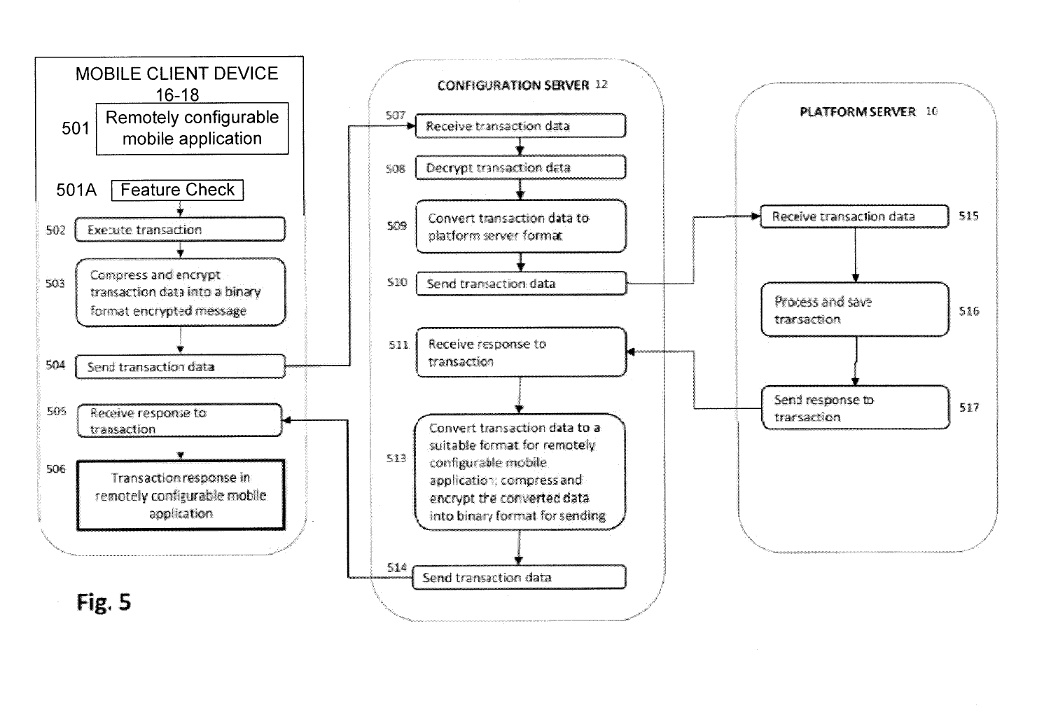

FIG. 5 depicts an example of a process for an end-to-end service transaction from a mobile client device 16-18 with a remotely configurable mobile application via a configuration server 12 to a platform server 10 running the service platform, which processes the service transaction in question 516 and backwards then delivering the transaction response back to the mobile client device 16-18 with the application via the configuration server 12.

In the example of FIG. 5, the connectivity between the mobile client device and the configuration server may be in accordance with process 199 noted above. When this is the case, the bearer selector selects the type of connectivity based on features and the like being used by the mobile client application at the mobile client device. For example, at 507 and 514 described below, the bearer selector may select a type of bearer based on process 199.

The remotely configurable mobile application 501 runs the mobile client device and a service trans-action is executed 502 by an application user, the transaction data is compressed into a binary format, encrypted message 503 and sent to the configuration server 504. In some example embodiments, between 501 and 502, a check at 501A of the feature configuration may be formed to determine what kind of the bearer is required (for example, IP, SMS, and the like), which can then be used during the sending at 504. In some example embodiments, the configuration server receives the transaction data 507, decrypts the data 508, converts the data into a format acknowledged by the platform server 509 and then sends the transaction forward 510 to the platform server 10. The platform server running the service platform processes and saves the transaction 516 after the transaction data has been received 515. After the transaction is processed 516, a transaction response is sent back to the configuration server 517. After receiving the response 511, the configuration server converts the transaction response to a format acknowledged by the mobile application, encrypts the converted data and compresses it into binary format for sending 513 and sends the response to transaction back to the mobile application 514 running in the mobile client device. After receiving the response to the transaction 505, the mobile application acts according to the response 506.

Referring again to FIG. 1C, the system may, in some example embodiments, include the remotely configurable mobile application in a mobile client device 16-18 that runs on any mobile OS such as Android, Windows Mobile, S40, SailFish, or iPhone OS, for example, but not limited to these. The system may, in some example embodiments, further include a configuration server 12 providing the tools and means for remote configuration of the mobile application regardless of the operating system of the mobile client device 16-18 and enabling communication with the mobile client device running the mobile application through a narrow communication channel by utilizing encrypted, communication channel independent messages 13-15 that allow communication also in a low-connectivity context and communication with a platform server 10 running the actual service platform also through a secure communication channel 11. The system may, in some example embodiments, further include A platform server 10 running the actual service platform connected with a configuration server 12 through a secure communication channel 11.

In the example embodiment of FIG. 1C, the remotely configurable mobile application in the mobile client 16-18 may render a set of functionalities implemented advantageously as transaction forms and defined remotely in the configuration server 12. Each transaction form may implement a specific service use case that may depend on the area of service supported by the application such as financial, insurance related or rental service, for example. The remotely configurable mobile application allows a user to execute service transactions 502 by posting a transaction request data 503-504 through utilizing one of the available transaction forms to the configuration server. The configuration server optimizes 511, secures 513, and transports 514 data between the mobile application in the mobile client and the configuration server both in a limited and non-limited connectivity context. The data can be configuration data, application management data or service transaction related data acknowledged by the configuration server and the remotely configurable mobile application.

In the example embodiments of FIG. 1C, the configuration server 12 creates and manages the set of service transaction forms that need to be rendered and made available to the remotely configurable mobile application in the mobile client, for example in phases 212-213 or 217-218 in FIG. 2, and receives service transaction request data 507 submitted by the application 504 through one of the available transaction forms 502. In the example embodiments, the configuration server 12 acts as a gateway towards the platform server 10 running the service platform by forwarding the transaction request data 510 to the platform server and processing the incoming transaction result and response 511-514 back to the remotely configurable mobile application in the mobile client device 16-18.

In some example embodiments, the configuration server 12 may provide a graphical user interface through which a service provider is able to create and manage the set of service transaction forms, for example in phases 212-213 or 217-218 in FIG. 2, and remotely control the use of the mobile applications running in the mobile client devices, for example in phases 313 and 319 in FIG. 3 or 413 and 419 in FIG. 4.

The configuration server 12 may also take care of converting the sent and received transaction data into a format acknowledged by the platform server 10 and the remotely configurable mobile application in the mobile client device 16-18 as presented in phases 509 and 513, for example. The data may also be configuration data, for example in phases 212 or 218 in FIG. 2, or application management data, for example in phases 314 and 320 in FIG. 3 or 414 and 420 in FIG. 4, acknowledged by the configuration server and the remotely configurable mobile application. The data is passed between the configuration server and the remotely configurable mobile application in the mobile client device in encrypted, communication channel independent configuration and management messages which are compressed into binary format and therefore may advantageously also be operable in a limited-connectivity context over narrow communication channels such as SMS or US SD, for example, but limited to these.

In some example embodiments, the state of the each instance of the remotely configurable mobile application, as well as the state of the platform server, is stored in a database on the configuration server. This allows the configuration server to be constantly aware of the situation of each instance of the remotely configurable mobile application running in the mobile client devices and using the service as well as dynamically adapt towards any service platform running on the platform server by mapping the received form data with parameters of the platform server Application Provider Interface (API).

The following provides example embodiments related to a mobile application configure as a mobile payment application or a mobile financial application, although other types of application may be used as well. The system for a remotely configurable mobile financial application may include: a remotely configurable mobile application in mobile client device 16-18 that runs on any mobile OS such as Android, Windows Mobile, S40, SailFish, or iPhone OS, for example, but not limited to these; a configuration server 12 providing the tools and means for remote configuration of the mobile application 16-18 regardless of the operating system of the mobile client device and enabling communication with the mobile client device running the mobile application through a narrow communication channel by utilizing encrypted, communication channel independent messages 13-15 that allow communication also in a low-connectivity context and communication with a platform server 10 running the actual service platform also through a secure communication channel 11; and a platform server 10 running the actual service platform connected with a configuration server 12 through a secure communication channel 11.

The remotely configurable mobile application in the mobile client 16-18 renders a set of functionalities, in some example embodiments, implemented as transaction forms and defined remotely in the configuration server. Each transaction form may correspond to and implement a specific financial use case such as Send Money, Pay Bill or Airtime Top-Up, for example, but not limited to these. The remotely configurable mobile application allows a user to execute service transactions 502 by posting transaction request data using one of the available transaction forms to the configuration server 503-504. The configuration server optimizes 511, secures 513, and transports 514 data between the mobile application in the mobile client and the configuration server both in a limited and non-limited connectivity context. The data can be configuration data, application management data or service transaction related data acknowledged by the configuration server and the remotely configurable mobile application.

In some example embodiments, the configuration server creates and manages the set of financial service transaction forms such as Send Money, Pay Bill or Airtime Top-Up, for example, that need to be rendered and made available to the remotely configurable mobile financial application in the mobile client device. The configuration server also receives financial service transaction request data submitted by the mobile application through one of the available transaction forms. The configuration server acts as a gateway towards the platform server running the financial service platform by forwarding the financial transaction request data to the platform server and processing the incoming financial transaction result and response back to the remotely configurable mobile financial application in the mobile client. The configuration server also takes care of converting the sent and received transaction data into a format acknowledged by the platform server and the remotely configurable mobile financial application.

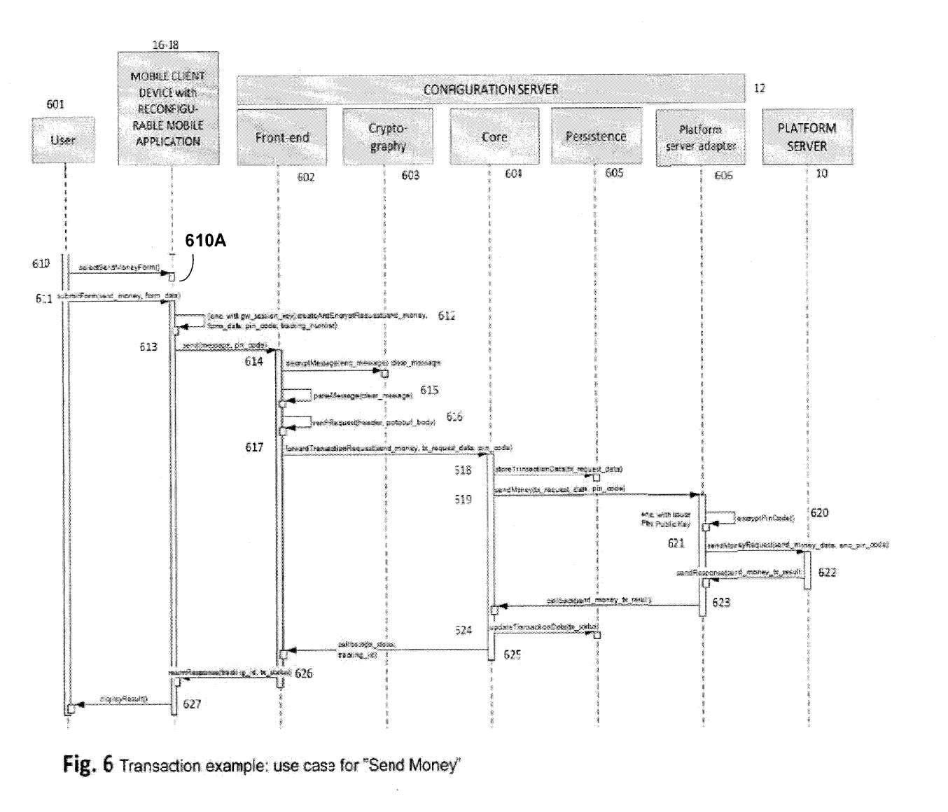

FIG. 6 shows a process for a service transaction concerning sending money in a use case related to a remotely configurable mobile financial application, in accordance with some example embodiments. The configuration server relies further on three logic layers described in FIG. 6. These three logic layers are the front-end 602, the core 604, and the adapter 606.

In the example of FIG. 6, the connectivity between the mobile client device and the configuration server may be in accordance with process 199 noted above. When this is the case, the bearer selector selects the type of connectivity based on features and the like being used by the mobile client application at the mobile client device. For example, at 610, 611, and 627 described below, the bearer selector may select a type of bearer based on process 199.

The front-end 602 is the entry point of the configuration server from the perspective of the remotely configurable mobile financial application in the mobile client device 16-18. The front-end 602 contains a messaging layer and handles security aspects, such as message encryption and decryption by interfacing with a dedicated security module 603, handles communications through communication channels such as SMS or USSD, for example, but not limited to these, especially in a limited connectivity context where only narrow communication channels are usable but through IP channels as well. The front-end 602 interacts with the core component 604 of the configuration server. For example, when a user 601 of the remotely configurable mobile financial application in the mobile client device 16-18 requests a certain financial transaction such as send money 610-613, the front-end 602 interfaces with a dedicated security module 603 in order to decrypt the received transaction request message 614. After parsing the received message 615 and verifying the request 616, the front-end 602 forwards the transaction request 617 to the core 604.

In some example embodiments, between 610 and 611, bearer selection may be performed at 610A. This selection may be based on configuration file instructions related to context, such as location, network, availability, and the like.

The core 604 handles the state of the whole system, the business domain and the business logic of the configuration server. When the remotely configurable mobile financial application in the mobile client device 16-18 requests a certain financial transaction such as send money 610-613, the core 604 first, after receiving the forwarded transaction request 617 from the front-end 602, executes internal business logic against its database 605 such as registering the transaction data and its related tracking number 618. After that the core 604 forwards the transaction request 619 to the adapter layer 606.

The adapter layer 606 is made of adapter APIs exposing the platform server APIs available and includes implementation to interact with the platform server 10 running the actual financial service platform that will process the actual service transaction, such as send money 621 and based on its processing provides a response to the specific service transaction, such as send money 622 back to the adapter layer of the configuration server 606.

The configuration server 12 takes care of forwarding the received service transaction response back to the remotely configurable mobile financial application in the mobile client device by forwarding the transaction response 623 to the core 604. The core 604 runs its internal business logic against its database in order to map the received responses with the previously sent transaction request 624 before forwarding the response to the front-end 625. The front-end 602 utilizes the messaging layer to return the service transaction response 626 to the mobile application 16-18 to be displayed 627 to the application user 601.

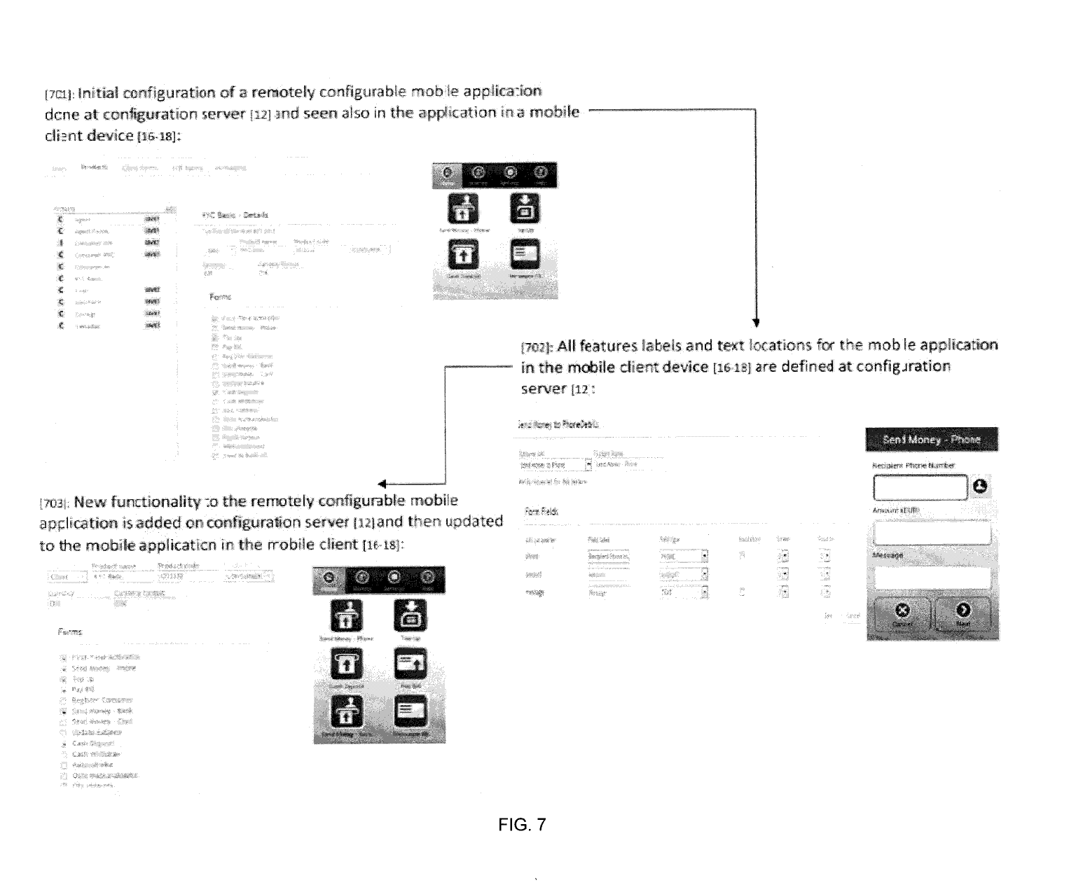

In addition to the logic layers of the configuration server 12 described above and handling the interactions with the remotely configurable mobile financial application in the mobile client device 16-18 on one side and the platform server 10 running the actual financial service platform on the other side, the configuration server 12 as a sub-system also includes a Web Administrative User Interface (Web Admin UI) to define the financial services and forms to be deployed to its remotely configurable mobile financial applications as described in FIG. 7.

FIG. 7 illustrates an example embodiment for initializing and modifying the menu and functionality of a remotely configurable mobile application in a configuration server by utilizing tools with a Web Admin UI for configuration, in accordance with some example embodiments. FIG. 7 also shows also the connection of the implemented changes within the mobile application's user interface in three example phases. In the first phase 701, the initial configuration of the remotely configurable mobile application is, in some example embodiments, defined at the configuration server 12 through the graphical user interface for configuration and seen also in the mobile application displayed in the mobile client device 205 after the process for requesting the initial configuration has been executed as described with respect to the example at FIG. 2. The second phase 702 illustrates that, for example, all labels for features and functionalities, text locations and other properties for the mobile application in the mobile client device 16-18 may be defined at the configuration server 12 as part of the initial configuration as in phase 212 in FIG. 2. The third phase 703 illustrates that new functionality to the remotely configurable mobile application may, in some example embodiments, be added on the configuration server 217 and then updated to the mobile application in the mobile client device 211 as presented in FIG. 2, for example.

An example configuration of the remotely configurable mobile financial application in the mobile client device through the Web Admin UI in the configuration server 12 is further described as follows. The Web Admin UI user, a money issuer, uses the Web Admin UI in the configuration server to create a financial product basically as a collection of forms and the forms are created to correspond to the available services exposed by the financial service platform running on the platform server, such as send money, top up, or pay bill, for example, but not limited to these as presented in phase 701. To create a form, the money issuer needs to select a platform server API corresponding to the financial service in question such as “Send Money to Phone Number,” for example, and each platform server API has an implicit feature or functionality type being materialized as the main menu of the remotely configurable mobile financial application in the mobile client device. To create a form, the money issuer also needs to provide a form label which is materialized as a sub-menu of the remotely configurable mobile financial application in the mobile client device such as “Send Money to Phone Number”, for example, as presented in phase 702. To create a form, the money issuer also needs to define input fields of the form, for example Mobile Subscriber ISDN (MSISDN) or amount message, needed to execute a “Send Money to Phone Number” financial transaction, for example. The data posted through the created form will be forwarded by the configuration server to the platform server to execute the actual transaction and the form fields may have different data types, such as text, numeric or a list of choice, and different validation schemes, such as phone number, email address or amount, as well as a position within a screen, for example. Once the money issuer has defined its products and assigned the corresponding forms, the financial service is ready to be used by the end user.

At configuration admin UI 702, a view or user interface element may, in some example embodiments, be provided where a preferred or a mandatory communication bearer may be defined for one or more functions, one or more mobile applications, one or more features, and the like available at the mobile device. Additionally, configuration parameters related to bearer may be defined via the admin interface, such as an SMSC number, an SMS aggregator number, and/or an IP address(es).

An example of a first-time use of remotely configurable mobile financial application in the mobile client device is described as follows. In order to use the service through the remotely configurable mobile financial application in the mobile client device for the first time, an end user may first need to install the initial remotely configurable mobile financial application package or definition file through a download service or side installation like also described on high level in FIG. 2 in phases 201-202, for example. After the initial installation, the remotely configurable mobile financial application in the mobile client device does not yet contain any features or functionalities of the financial service and service transactions. Therefore the end user runs for example a configuration wizard which includes selecting one of the financial products created and made available by the money issuer through the Web Admin UI on the configuration server as presented as an example in FIG. 7 in phases 701 and 702. In some example embodiments, the selection of the financial product triggers communication with the server to request the configuration of the selected product, as for example in FIG. 2 in phases 202-203, and as a response, the user receives the full collection of forms assigned to this product as described on high level in FIG. 2 in phase 204 based on configuration available in phase 212, for example. Once the forms are stored locally, the remotely configurable mobile and functionality types accessible to the end user as well as all the forms corresponding to the financial transaction services that the end users can utilize as described in FIG. 2 in phase 205 and in FIG. 7 in phases 701 and 702, for example. In some example embodiments, the remotely configurable mobile financial application in the mobile client device acts as a rendering engine for the main menu, sub-menus and form definitions received through the communication channel during the configuration and each functionality is displayed dynamically according to the received configuration. In some example embodiments, communication between the remotely configurable mobile financial application and the configuration server may be based on compressed, encrypted, binary format configuration and management messages that can be passed over a narrow communication channel such as SMS or USSD, for example, even in a low-connectivity context and contain data for configuration of the application or managing the application or service transactions.

Without in any way limiting the scope, interpretation, or application of the claims appearing below, the technical effects of the invention as described in the previous exemplary embodiments are formed based on the advantageous factor that once a remotely configurable mobile application in a mobile client device has been set up and configured as described in connection with the previous exemplary embodiments, for example, it is possible to completely renew its functionality without a need to re-install the software package of the application but by simply updating its locally stored forms and, advantageously, the updates can be created in a configuration server. The dynamic nature of the rendering engine of the remotely configurable mobile application means that as soon as a new set of forms has been received from the configuration server, the displayed UI consisting of the menu and functionality of the application is updated straight away and, advantageously, the application stays ready for use without any major disturbance. Such remote control of the application also ensures a full control of the set of services that a service provider exposes to its remotely configurable mobile applications. It also allows easy discarding of unwanted or blacklisted clients by allowing remote disabling and enabling of the application as well blocking and unblocking of the application in a similar remote manner A financial application is presented as one advantageous embodiment but the same could be applied to several service areas such as insurance related services or rental services, for example.

Without in any way limiting the scope, another technical effect of the invention is that the configuration of the mobile application is purely independent from the mobile client devices with the remotely configurable mobile application. Therefore the OS of the mobile client device has no significance in the utilization of the invention but instead the invention advantageously is independent of the mobile operating systems. Also, the service platform has very little significance and the invention can be applied to basically any service platform with a simple adaptation.

Without in any way limiting the scope, a further technical effect of the invention is evident in the limited connectivity context as the communication channel required for configuration and management messaging between the configuration server and the remotely configurable mobile application in the mobile client device is very narrow and communication channels such as SMS or USSD, for example, are utilized.

Without in any way limiting the scope, a further technical effect is the selection by the mobile application of an appropriate bearer, such as a low capacity bearer (for example, SMS, USSD, and the like) or a higher capacity bearer (for example, an IP bearer) based on the context of the mobile application.

In the following description, considered embodiments are merely exemplary, and one skilled in the art may find other ways to implement the invention. Although the specification may refer to “an”, “one” or “some” embodiment(s) in several locations, this does not necessarily mean that each such reference is made to the same embodiment(s), or that the feature only applies to a single embodiment or all embodiments. Single feature of different embodiments may also be combined to provide other embodiments. Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

1. A method comprising:
receiving, at a mobile application, bearer configuration information representative of one or more features of the mobile application mapped to at least one of a low capacity bearer or a high capacity bearer;
determining, at the mobile application, a context of the mobile application, the context determined by at least determining a feature selected via the mobile application and determining an identity of a bearer mapped to the feature in the received bearer configuration information;
selecting, based on the determining, the at least one of the low capacity bearer or the high capacity bearer; and
allowing the feature to access the selected at least one of the low capacity bearer or the high capacity bearer.

2. The method of claim 1 further comprising:
modifying the bearer configuration information previously configured for the mobile application.

3. The method of claim 1 further comprising:
receiving bearer configuration information representative a priority order giving a preference to at least one bearer over another bearer; and
selecting, based on the determined context, the at least one bearer or the other bearer in the priority order.

4. The method of claim 1 further comprising:
determining a performance of a device hosting the mobile application; and
determining whether to allow the feature based on the determined performance.

5. The method of claim 1, wherein the low capacity bearer includes at least one of a short message service bearer, a secure short message service bearer, and an unstructured supplementary service data bearer.

6. The method of claim 1, wherein the high capacity bearer includes an internet protocol bearer.

7. The method of claim 1, wherein the context further includes at least one of the following: a bandwidth requirement of the feature; a user preference for the low capacity bearer or the high capacity bearer; an availability of the low capacity bearer or the high capacity bearer; a network service provider preference for the low capacity bearer or the high capacity bearer; costs associated with the low capacity bearer or the high capacity bearer; a location of the mobile application; reliability of for the low capacity bearer or the high capacity bearer; and quality of service of the low capacity bearer or the high capacity bearer unreliability of user bearer.

8. The method of claim 1, wherein the mobile application performs the selecting and the allowing.

9. An apparatus comprising:
at least one processor circuitry; and
at least one memory circuitry including computer program code which when by the at least one processor circuitry causes at least the following:
receive, at a mobile application, bearer configuration information representative of one or more features of the mobile application mapped to at least one of a low capacity bearer or a high capacity bearer;
determine, at the mobile application, a context of the mobile application, the context determined by at least determining a feature selected via the mobile application and determining an identity of a bearer mapped to the feature in the received bearer configuration information;
select, based on the determination, the at least one of the low capacity bearer or the high capacity bearer; and
allow the feature to access the selected at least one of the low capacity bearer or the high capacity bearer.

10. The apparatus of claim 9 further configured to at least modify the bearer configuration information previously configured for the mobile application.

11. The apparatus of claim 9 further configured to at least receive bearer configuration information representative a priority order giving a preference to at least one bearer over another bearer, and select, based on the determined context, the at least one bearer or the other bearer in the priority order.

12. The apparatus of claim 9 further configured to at least determine a performance of a device hosting the mobile application, determine whether to allow the feature based on the determined performance.

13. The apparatus of claim 9, wherein the low capacity bearer includes at least one of a short message service bearer, a secure short message service bearer, and an unstructured supplementary service data bearer.

14. The apparatus of claim 9, wherein the high capacity bearer includes an internet protocol bearer.

15. The apparatus of claim 9, wherein the context further includes at least one of the following: a bandwidth requirement of the feature; a user preference for the low capacity bearer or the high capacity bearer; an availability of the low capacity bearer or the high capacity bearer; a network service provider preference for the low capacity bearer or the high capacity bearer; costs associated with the low capacity bearer or the high capacity bearer; a location of the mobile application; reliability of for the low capacity bearer or the high capacity bearer; and quality of service of the low capacity bearer or the high capacity bearer unreliability of user bearer.

16. The apparatus of claim 9, wherein the mobile application includes a mobile payment application, and wherein the mobile application performs the select and the allow.

17. A non-transitory computer-readable storage medium including computer program code which when executed by at least one processor circuitry causes operations comprising:
receive, at a mobile application, bearer configuration information representative of one or more features of the mobile application mapped to at least one of a low capacity bearer or a high capacity bearer;
determine, at the mobile application, a context of the mobile application, the context determined by at least determining a feature selected via the mobile application and determining an identity of a bearer mapped to the feature in the received bearer configuration information;
select, based on the determination, the at least one of the low capacity bearer or the high capacity bearer; and
allow the feature to access the selected at least one of the low capacity bearer or the high capacity bearer.

18. The non-transitory computer-readable storage medium of claim 17 further comprising:
modifying the bearer configuration information previously configured for the mobile application.

19. The non-transitory computer-readable storage medium of claim 17 further comprising:
receiving bearer configuration information representative a priority order giving a preference to at least one bearer over another bearer; and
selecting, based on the determined context, the at least one bearer or the other bearer in the priority order.

20. The non-transitory computer-readable storage medium of claim 17 further comprising:
determining a performance of a device hosting the mobile application; and
determining whether to allow the feature based on the determined performance.

21. The non-transitory computer-readable storage medium of claim 17, wherein the low capacity bearer includes at least one of a short message service bearer, a secure short message service bearer, and an unstructured supplementary service data bearer.

22. An apparatus comprising:
means for receiving, at a mobile application, bearer configuration information representative of one or more features of the mobile application mapped to at least one of a low capacity bearer or a high capacity bearer;
means for determining, at the mobile application, a context of the mobile application, the context determined by at least determining a feature selected via the mobile application and determining an identity of a bearer mapped to the feature in the received bearer configuration information;
means for selecting, based on the determination, the at least one of the low capacity bearer or the high capacity bearer; and
means for allowing the feature to access the selected at least one of the low capacity bearer or the high capacity bearer.
